(19) United States
(12) Patent Application Publication
(10) Pub. No.: US 2023/0074464 A1
(43) Pub. Date: Mar. 9, 2023

(54) RANGE-FINDING APPARATUS AND RANGE-FINDING METHOD

(71) Applicants: SONY SEMICONDUCTOR SOLUTIONS CORPORATION, KANAGAWA (JP); SONY GROUP CORPORATION, TOKYO (JP)

(72) Inventors: TAKAHIRO AKAHANE, KANAGAWA (JP); YUSUKE IKEDA, KANAGAWA (JP); SHUN KAIZU, TOKYO (JP); EIJI HIRATA, TOKYO (JP); HIROSHI YUASA, TOKYO (JP); SHINICHIROU ETOU, KANAGAWA (JP); YASUTAKA KIMURA, KANAGAWA (JP); TAKESHI OYAKAWA, KANAGAWA (JP); NAOKI YOSHIMOCHI, KANAGAWA (JP)

(21) Appl. No.: 17/795,507

(22) PCT Filed: Jan. 25, 2021
(86) PCT No.: PCT/JP2021/002394

§ 371 Date: Jul. 26, 2022

(30) Foreign Application Priority Data
Feb. 3, 2020 (JP) 2020-016562

(51) Int. Cl. G01S 17/08; G01S 7/481; G01B 11/25

(52) U.S. Cl. CPC G01S 17/08; G01S 7/4814; G01B 11/25

(57) ABSTRACT

The range-finding apparatus (1) includes an optical receiver (110), a light source unit (200), a converter (134), and a calculation unit (300). The optical receiver (110) receives light to output a pixel signal. The light source unit (200) projects light with a first irradiation pattern in a first period and projects light with a second irradiation pattern in a second period. The converter (134) sequentially converts the pixel signal bit by bit using binary search to output a first digital signal and a second digital signal, the first digital signal being output by performing the conversion with a first bit width in the first period, the second digital signal being output by performing the conversion with a second bit width in the second period, the second bit width being less than the first bit width. The calculation unit (300) calculates a distance on the basis of the first digital signal and the second digital signal.

### TECHNICAL FIELD

The present disclosure relates to a range-finding apparatus and a range-finding method.

### BACKGROUND ART

One technique for determining the three-dimensional shape of an object is known as a spatial coding technique. The spatial coding technique determines the three-dimensional shape, for example, using a plurality of captured images obtained by emitting and capturing a striped pattern with different periods.

### CITATION LIST

### Non-Patent Document

Non-Patent Document 1: J. L. Posdamer, M. D. Altschler, “Surface Measurement by Space-Encoded Projected Beam Systems”, Computer Graphics and Image Processing vol. 18, Not, pp. 1-17, 1982.

### SUMMARY OF THE INVENTION

### Problems to be Solved by the Invention

The spatial coding technique is to acquire a plurality of captured images. Thus, image-capturing devices in the related art have had a problem with time-consuming to acquire a plurality of captured images and difficulty in metering, for example, the three-dimensional shape of a high-speed moving object (the distance to a to-be-measured object).

Thus, the present disclosure provides a range-finding apparatus and method capable of calculating the distance to a to-be-measured object at a higher speed.

### Solutions to Problems

According to the present disclosure, a range-finding apparatus is provided. The range-finding apparatus includes an optical receiver, a light source unit, a converter, and a calculation unit. The optical receiver receives light to output a pixel signal. The light source projects light with a first irradiation pattern in a first period and projects light with a second irradiation pattern in a second period. The converter sequentially converts the pixel signal bit by bit using binary search to output a first digital signal and a second digital signal, the first digital signal being output by performing the conversion with a first bit width in the first period, the second digital signal being output by performing the conversion with a second bit width in the second period, the second bit width being less than the first bit width. The calculation unit calculates a distance on the basis of the first digital signal and the second digital signal.

### BRIEF DESCRIPTION OF DRAWINGS

FIG. 1 is a diagram illustrating an exemplary schematic configuration of a range-finding apparatus according to a first embodiment of the present disclosure.

FIG. 2 is a diagram illustrating an exemplary configuration of an image-capturing device according to the first embodiment of the present disclosure.

FIG. 3 is a diagram illustrating an exemplary configuration of a column ADC and a control unit according to the first embodiment of the present disclosure.

FIG. 4 is a diagram illustrated to describe A/D conversion by the column ADC according to the first embodiment of the present disclosure.

FIG. 5 is a timing chart schematically illustrating the readout of a pixel signal by the image-capturing device according to the first embodiment of the present disclosure.

FIG. 6 is a block diagram illustrating an exemplary configuration of a range-finding apparatus according to the first embodiment of the present disclosure.

FIG. 7 is a diagram illustrated to describe an example of timing control by a timing control unit according to the first embodiment of the present disclosure.

FIG. 8 is a diagram illustrated to describe an example of an irradiation pattern transferred by a projection image generation unit according to the first embodiment of the present disclosure.

FIG. 9 is a diagram illustrated to describe an example of an irradiation pattern transferred by a projection image generation unit according to the first embodiment of the present disclosure.

FIG. 10 is a block diagram illustrating an exemplary configuration of a signal processing unit according to the first embodiment of the present disclosure.

FIG. 11 is a diagram illustrated to describe confidence coefficient calculation by a confidence coefficient generation unit according to the first embodiment of the present disclosure.

FIG. 12 is a diagram illustrated to describe a way to calculate a depth by a depth estimator according to the first embodiment of the present disclosure.

FIG. 13 is a flowchart illustrating an exemplary schematic operation of the range-finding apparatus according to the first embodiment of the present disclosure.

FIG. 14 is a diagram illustrating an example of the arrangement of pixels of an image-capturing device according to a second embodiment of the present disclosure.

FIG. 15 is a diagram illustrating another example of the arrangement of pixels of the image-capturing device according to the second embodiment of the present disclosure.

FIG. 16 is a timing chart schematically illustrating the readout of a pixel signal by the image-capturing device according to the second embodiment of the present disclosure.

FIG. 17 is a diagram illustrated to describe another example of the image-capturing timing of the image-capturing device according to the second embodiment of the present disclosure.

FIG. 18 is a diagram illustrating an example of the arrangement of pixels of an image-capturing device according to a third embodiment of the present disclosure.

FIG. 19 is a diagram illustrated to describe an example of the image-capturing timing of the image-capturing device according to the third embodiment of the present disclosure.

FIG. 20 is a diagram illustrated to describe another example of the image-capturing timing of the image-capturing device according to the third embodiment of the present disclosure.

FIG. 21 is a diagram illustrated to describe confidence coefficient calculation by a confidence coefficient generation unit according to a fourth embodiment of the present disclosure.

FIG. 22 is a diagram illustrated to describe the confidence coefficient calculation by the confidence coefficient generation unit according to the fourth embodiment of the present disclosure.

### MODE FOR CARRYING OUT THE INVENTION

Hereinafter, a preferred embodiment of the present disclosure will be described in detail with reference to the appended drawings. Note that, in this specification and the appended drawings, components that have substantially the same function and configuration are denoted with the same reference numerals, and repeated explanation of these structural elements is omitted.

The description is given in the following order.

1. First Embodiment

1.1. Exemplary Schematic Configuration of Range-Finding Apparatus

1.2. Image-Capturing Device

1.3. Entire-Apparatus Control Unit of Range-Finding Apparatus

1.4. Exemplary Operation of Range-Finding Apparatus

2. Second Embodiment

3. Third Embodiment

4. Fourth Embodiment

5. Other Embodiments

6. Supplement

### 1. First Embodiment

<1.1. Exemplary Schematic Configuration of Range-Finding Apparatus>

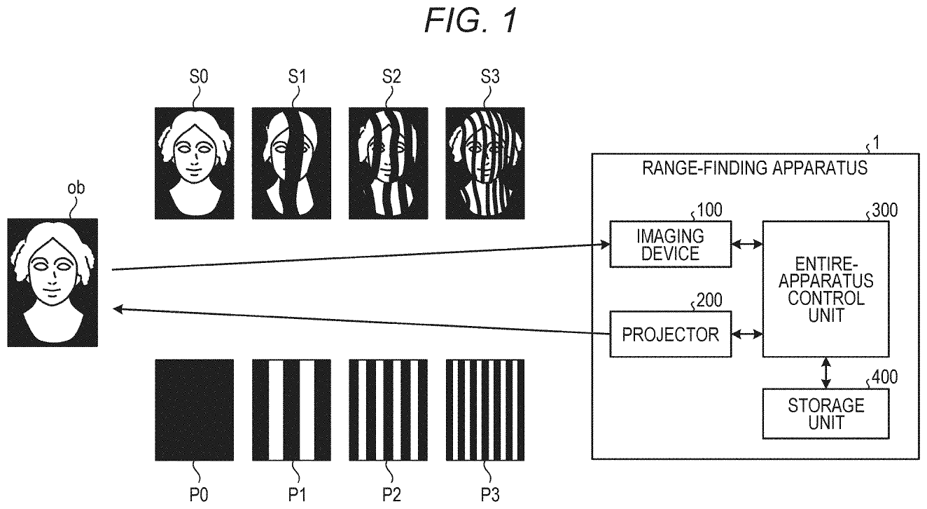

FIG. 1 is a diagram illustrating an exemplary schematic configuration of a range-finding apparatus 1 according to a first embodiment of the present disclosure. The range-finding apparatus 1 includes, for example, an image-capturing device 100, a projector 200, an entire-apparatus control unit 300, and a storage unit 400, as illustrated in FIG. 1. The range-finding apparatus 1 measures the distance to a to-be-measured object ob using a spatial coding technique to meter the three-dimensional shape of the to-be-measured object ob.

The projector 200 is a light source that projects a predetermined projection image in accordance with instructions of the entire-apparatus control unit 300. The predetermined projection image is, for example, a light-dark pattern with different periods. The projector 200 irradiates the to-be-measured object ob with the irradiation light of the light-dark pattern. In the example of FIG. 1, the projector 200 sequentially irradiates it with the irradiation light of irradiation patterns P0 to Pn to be used as a predetermined projection image, where n=3 in FIG. 1.

Moreover, the irradiation pattern P0 is used for capturing a background image (a first irradiation pattern, and hereinafter also referred to as a background irradiation pattern). The background irradiation pattern P0 is, for example, a black projection image (the irradiation pattern is all “dark”), that is, an irradiation pattern that does not apply the irradiation light. The projector 200 projects the background irradiation pattern P0 in a first period. The irradiation patterns P1 to Pn are a second irradiation pattern with different widths of the vertical stripes in the example of FIG. 1. The projector 200 projects the irradiation patterns P1 to Pn in a second period.

The image-capturing device 100 captures an image of the to-be-measured object ob in synchronization with the projection of the irradiation patterns P0 to Pn by the projector 200 in accordance with the instruction of the entire-apparatus control unit 300. The image-capturing device 100 outputs captured images S0 to Sn corresponding to the respective irradiation patterns P0 to Pn to the entire-apparatus control unit 300.

The image-capturing device 100 according to the present embodiment outputs the captured image S0 to the entire-apparatus control unit 300. The captured image S0 (hereinafter also referred to as a background image) is obtained by capturing the to-be-measured object ob irradiated with the irradiation light of the irradiation pattern P0 (the background irradiation pattern). The pixel signal (luminance value) of each pixel in the background image S0 is a first digital signal that is subjected to analog-to-digital conversion with a first bit width (e.g., 10 bits).

Further, the captured images S1 to Sn obtained by capturing the to-be-measured object ob upon being irradiated with the irradiation light of the irradiation patterns P1 to Pn are images indicating whether or not the irradiation light is applied. The pixel signals of the captured images S1 to Sn are second digital signals with a second bit width (e.g., one bit) less than the first bit width. The captured images S1 to Sn, other than the background image S0, are now also referred to as differential images S1 to Sn.

The image-capturing device 100 according to the present embodiment described above outputs the background image S0 of multiple bits and the differential images S1 to Sn of one bit. This configuration eliminates the need to calculate the difference between the captured images for calculation of the distance in the subsequent signal processing by the entire-apparatus control unit 300. In addition, the differential images S1 to Sn output by the image-capturing device 100 are one-bit images, shortening the time the image-capturing device 100 outputs the differential images S1 to Sn. Thus, the range-finding apparatus 1 is capable of acquiring the differential images S1 to Sn at a higher speed. Moreover, the image-capturing device 100 is described later in detail.

The entire-apparatus control unit 300 controls individual components of the range-finding apparatus 1. The entire-apparatus control unit 300 controls, for example, the projector 200 so that the projector 200 applies the predetermined irradiation light of the irradiation pattern P0 to Pn. In addition, the entire-apparatus control unit 300 controls the image-capturing device 100 so that the image-capturing device 100 captures an image of the to-be-measured object ob while the projector 200 applies the irradiation light of the predetermined irradiation patterns P0 to Pn.

The entire-apparatus control unit 300 operates as a calculation unit that calculates a depth (distance to the to-be-measured object ob) in each pixel of the captured images S0 to Sn on the basis of the plurality of captured images S0 to Sn captured by the image-capturing device 100. The way to calculate the depth by the entire-apparatus control unit 300 is described later.

The storage unit 400 stores information that can be used for range-finding of the to-be-measured object ob by the range-finding apparatus 1, such as the irradiation patterns P0 to Pn.

Moreover, the number of irradiation patterns projected by the projector 200 is herein set to, but not limited to, four. A plurality, for example, two or three, or five or more of the irradiation patterns, can be used. In addition, the irradiation pattern of vertical stripes with different periods is herein used, but the irradiation pattern is not limited to this type of pattern. In one example, the irradiation pattern can be a pattern of horizontal stripes. In addition, the pattern can be a combination of vertical stripes and horizontal stripes. The irradiation pattern can be any pattern that can be binary coded.

Further, the irradiation pattern Pn to be applied in the last order among the irradiation patterns P1 to Pn is herein the second irradiation pattern of the vertical stripes, but the irradiation pattern Pn can be the same irradiation pattern as the irradiation pattern P0 (a third irradiation pattern). In this case, the captured image Sn corresponding to the irradiation pattern Pn is used for the entire-apparatus control unit 300 to set a confidence coefficient of the depth. Setting the confidence coefficient is described later.

<1.2. Image-Capturing Device>

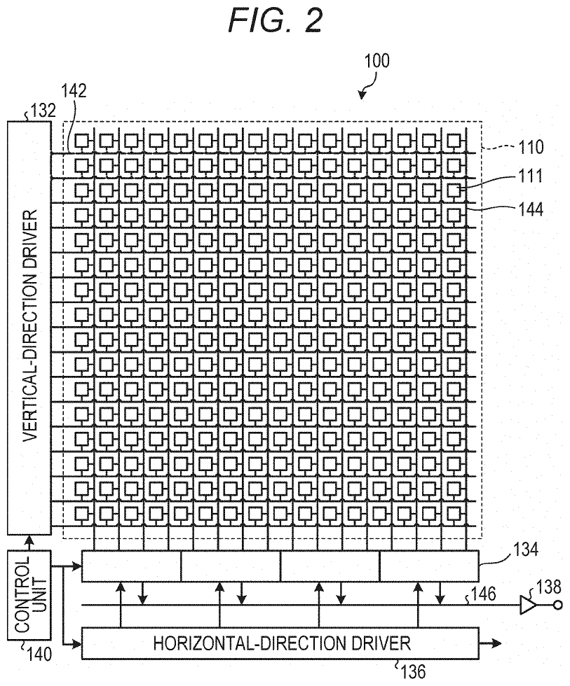

The image-capturing device 100 according to the first embodiment of the present disclosure is now described in detail with reference to FIGS. 2 to 4. FIG. 2 is a diagram illustrating an exemplary configuration of an image-capturing device 100 according to the first embodiment of the present disclosure.

The image-capturing device 100 includes a pixel array section (an optical receiver) 110 with a plurality of pixels (image capturing elements) 111 arranged and a peripheral circuit provided to surround the pixel array section 110, as illustrated in FIG. 2. The peripheral circuit includes a vertical-direction driver 132, a column signal processing circuit 134, a horizontal-direction driver 136, an output circuit 138, a control unit 140, and the like. The pixel array section 110 and the peripheral circuit are described below in detail.

The pixel array section 110 has a plurality of pixels 111 arranged in a two-dimensional matrix on a semiconductor substrate. Each of the pixels 111 has a photoelectric transducer and a plurality of pixel transistors (not illustrated). More specifically, the pixel transistor can include, for example, a transfer transistor, a selection transistor, a reset transistor, an amplification transistor, and the like.

The vertical-direction driver 132 includes, for example, a shift register. The vertical-direction driver 132 selects a pixel drive line 142 and supplies a pulse to the selected pixel drive line 142 to drive the pixel 111 for each row. The pulse is used to drive the pixel 111. In other words, the vertical-direction driver 132 performs selective scanning for the respective pixels 111 of the pixel array section 110 in the vertical direction (up-and-down direction in FIG. 2) sequentially for each row. The vertical-direction driver 132 supplies a pixel signal to the column signal processing circuit 134 described later through a vertical signal line 144. The pixel signal is based on the electric charge produced depending on the intensity of light received by the photoelectric transducer of each pixel 111.

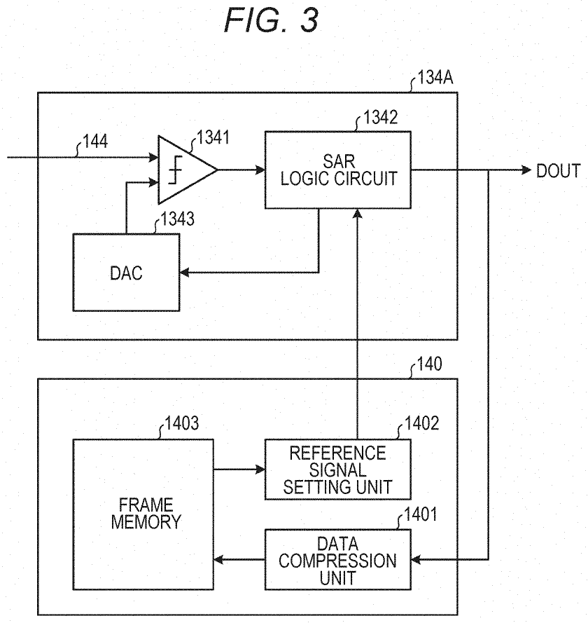

The column signal processing circuit 134 is arranged for each column of the pixels 111. The column signal processing circuit 134 performs signal processing such as noise reduction for each pixel column on a pixel signal output from the pixels 111 for each row. In one example, the column signal processing circuit 134 performs signal processing such as correlated doubles sampling (CDS), analog-to-digital (A/D) conversion, or the like to reduce a fixed-pattern noise due to pixel-to-pixel variability. The column signal processing circuit 134 has, for example, a successive-approximation register (SAR) column ADC 134A (see FIG. 3). The column ADC 134A is a converter that sequentially converts a pixel signal bit by bit using binary search to form a digital signal to be output.

The horizontal-direction driver 136 includes, for example, a shift register. The horizontal-direction driver 136 sequentially outputs a horizontal scanning pulse to select sequentially the column signal processing circuits 134 described above, which causes the pixel signals from the respective column signal processing circuits 134 to be output to a horizontal signal line 146.

The output circuit 138 performs signal processing on the pixel signal sequentially supplied from the respective column signal processing circuits 134 described above through the horizontal signal line 146 and outputs a signal being subjected. The output circuit 138 can function, for example, as a functional unit for buffering or can perform processing such as black level adjustment, column variation correction, or various types of digital signal processing. Moreover, buffering herein refers to temporarily storing the pixel signal to compensate for a difference in processing rate or transfer rate upon transmission and reception of pixel signals.

The control unit 140 can receive a clock being input and data used to indicate an operation mode or the like and can output data such as information regarding the pixel 111. In other words, the control unit 140 generates a clock signal and a control signal used as a reference for the operation of the vertical-direction driver 132, the column signal processing circuit 134, the horizontal-direction driver 136, or the like on the basis of the vertical synchronization signal, the horizontal synchronization signal, and the master clock. The control unit 140 then outputs the generated clock signal and control signal to the vertical-direction driver 132, the column signal processing circuit 134, the horizontal-direction driver 136, and the like on the basis of the vertical synchronization signal, the horizontal synchronization signal, and the master clock.

The control unit 140 adjusts a reference signal to be compared with the pixel signal in the SAR column ADC 134A, controlling the bit width of A/D conversion performed in the column ADC 134A. In one example, in the case of capturing the background image S0 used as a reference for range-finding, the control unit 140 controls a reference signal so that the pixel signal is converted into a first digital signal with multiple bits (e.g., 10 bits).

On the other hand, in the case of capturing the differential images S1 to Sn upon applying light of the predetermined irradiation patterns P1 to Pn, the control unit 140 controls the reference signal to determine whether or not the pixel signal is brighter than the background image S0. In other words, the control unit 140 controls the reference signal of the column ADC 134A to convert the pixel signal into the second digital signal of one bit indicative of whether or not the pixel signal is brighter than the background image S0. Moreover, the description below is given of using the bit width of 10 bits in the case where the column ADC 134A converts a pixel signal into a multi-bit digital signal, but the bit width is not limited to 10 bits. The bit width can be two or more, nine or less, or 11 or more, and in one example, it can be the maximum number of bits convertible by the column ADC 134A.

(Column ADC)

FIG. 3 is a diagram illustrating an exemplary configuration of a column ADC 134A and a control unit 140 according to the first embodiment of the present disclosure. The column signal processing circuit 134 has, for example, the column ADC 134A illustrated in FIG. 3 for each vertical signal line 144. Alternatively, a plurality of vertical signal lines 144 can share one column ADC 134A. In this case, a plurality of vertical signal lines 144 and the column ADC 134A are connected, for example, via a switch (not illustrated), which selects the pixel signal to be converted by the column ADC 134A.

The column ADC 134A includes a comparator 1341, a successive-approximation register (SAR) logic circuit 1342, and a digital-to-analog converter (DAC) 1343, as illustrated in FIG. 3.

The comparator 1341 compares a pixel signal input via the vertical signal line 144 with a predetermined reference signal. The comparator 1341 outputs the comparison result to the SAR logic circuit 1342.

The SAR logic circuit 1342 calculates a digital signal indicative of a value of the reference signal approximating the pixel signal on the basis of the comparison result from the comparator 1341 and stores it in a register. The SAR logic circuit 1342 generates a control signal to update the reference signal to the digital signal value.

The DAC 1343 updates the analog reference signal by subjecting the control signal to digital-to-analog (D/A) conversion.

(Control Unit)

An exemplary configuration of the control unit 140 is now described with reference to FIG. 3. The control unit 140 includes a data compression unit 1401, a reference signal setting unit 1402, and a frame memory 1403, as illustrated in FIG. 3.

The data compression unit 1401 compresses the first digital signal of 10 bits output by the SAR logic circuit 1342 to convert it into a digital signal having a bit width smaller than 10 bits (e.g., three bits) and stores the converted signal in the frame memory 1403. In other words, the data compression unit 1401 compresses the background image S0 and stores it in the frame memory 1403. Moreover, examples of a compression scheme performed by the data compression unit 1401 include lossless compression using a Huffman code, but such a compression scheme is illustrative, and various compression schemes are applicable.

The reference signal setting unit 1402 controls the SAR logic circuit 1342 so that the SAR logic circuit 1342 sets a reference signal (hereinafter also referred to as a one-bit reference signal) corresponding to the first digital signal (luminance value) in each pixel of the background image S0. The reference signal setting unit 1402, after acquiring the background image S0, controls the SAR logic circuit 1342 so that the SAR logic circuit 1342 sets the one-bit reference signal during applying light of the irradiation patterns P1 to Pn (i.e., while the differential images S1 to Sn are captured).

The frame memory 1403 is the storage means for storing the background image S0. The frame memory 1403 stores the background image S0 compressed by the data compression unit 1401. Storing the background image S0 compressed by the data compression unit 1401 in the frame memory 1403 is possible to reduce the size of the frame memory 1403. Moreover, if the frame memory 1403 has the capacity to store the background image S0 of 10 bits, the data compression unit 1401 can be omitted.

(A/D Conversion Processing)

In this example, the column ADC 134A is the SAR ADC as described above, and the DAC 1343 is provided individually for each column. Thus, the column ADC 134A is capable of adjusting an initial voltage (an initial value of the reference signal used for comparison in the comparator 1341) for each column. In considering such a configuration, changing the reference signal for each of the irradiation patterns P0 to Pn by the image-capturing device 100 changes the threshold value of the column ADC 134A in the present embodiment. This configuration makes it possible for the image-capturing device 100 to capture the 10-bit background image S0 and determine whether or not the pixel signal is brightened with one bit using the column ADC 134A in the case of applying light of the irradiation patterns P1 to Pn.

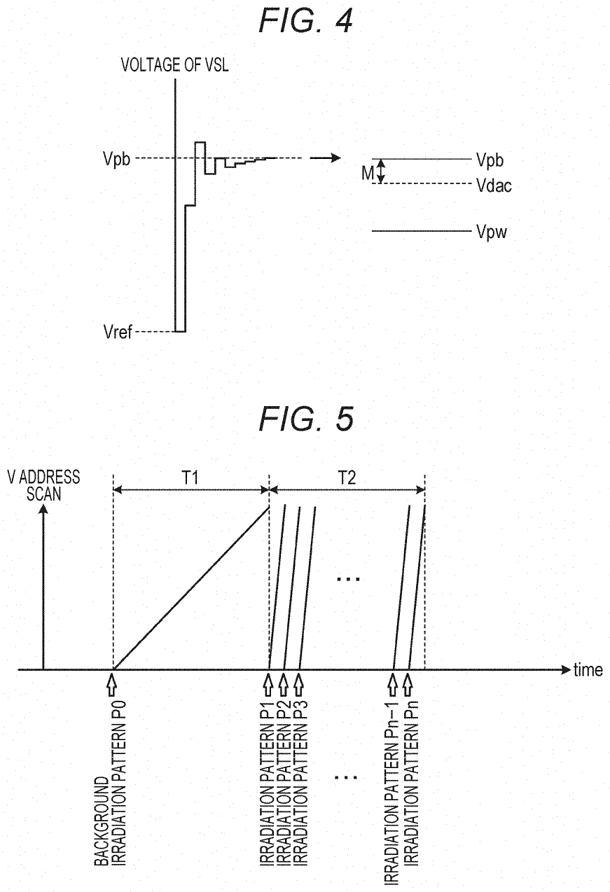

The comparison processing by the column ADC 134A is now described in detail with reference to FIG. 4. FIG. 4 is a diagram illustrated to describe A/D conversion by the column ADC 134A according to the first embodiment of the present disclosure. In FIG. 4, the lower side portion indicates a lower voltage state (white side), and the upper side portion indicates a higher voltage state (black side). In the graph illustrated on the left side of FIG. 4, the horizontal axis represents time.

(Multi-Bit A/D Conversion)

Referring to the graph illustrated on the left side of FIG. 4, the description is now given of a case where the column ADC 134A performs A/D conversion on a pixel signal Vpb of the background image S0 in a first period. In other words, a case where the column ADC 134A performs 10-bit A/D conversion is described.

The level of a reference signal VSL in the initial state is set to, for example, an initial value Vref. The comparator 1341 then compares the pixel signal Vpb with the reference signal of the initial value Vref. If the pixel signal Vpb is larger than the reference signal, the SAR logic circuit 1342 sets the most significant bit (MSB) of a digital signal DOUT to “0”. The SAR logic circuit 1342 then raises the voltage of the reference signal by Vref/2, as illustrated in FIG. 4.

On the other hand, if the pixel signal Vpb is equal to or less than the reference signal, the SAR logic circuit 1342 sets the MSB of the digital signal DOUT to “1”. The SAR logic circuit 1342 then drops the voltage of the reference signal by Vref/2 (not illustrated).

The comparator 1341 then performs a subsequent comparison. If the comparison results that the pixel signal Vpb is larger than the reference signal, the SAR logic circuit 1342 sets the digit following the MSB to “0”. The SAR logic circuit 1342 then raises the voltage of the reference signal by Vref/4, as illustrated in FIG. 4.

On the other hand, if the pixel signal Vpb is equal to or less than the reference signal, the SAR logic circuit 1342 sets the digit following the MSB to “1”. The SAR logic circuit 1342 then drops the voltage of the reference signal by Vref/4 (not illustrated).

Then, a similar processing procedure continues to the least significant bit (LSB). This configuration allows the analog pixel signal Vpb to be A/D-converted to the digital signal DOUT. Upon completing the A/D conversion, the SAR logic circuit 1342 outputs the first digital signal DOUT. The first digital signal DOUT indicates data obtained by A/D-converting the pixel signal Vpb (i.e., pixel data).

(One-Bit A/D Conversion)

The description is now given of a case where the column ADC 134A performs A/D conversion on a pixel signal Vpw of the differential image (differential image S1, in this example), other than the background image S0, in a second period. The description refers to the graph illustrated on the right side of FIG. 4. In other words, a case where the column ADC 134A performs 1-bit A/D conversion is described.

In this example, in the case of applying the irradiation light of the irradiation pattern P1, the pixel signal Vpw of a pixel obtained by capturing a region irradiated with the irradiation light (hereinafter also referred to as an irradiation pixel) is a signal with a brighter value than the pixel signal Vpb of the background image S0. In other words, the pixel signal Vpw of the irradiation pixel is smaller than the pixel signal Vpb. Moreover, the pixel signal Vpw of the captured image S1 and the pixel signal Vpb of the background image S0 are pixel signals of pixels with positions corresponding to each other in a frame.

On the other hand, the pixel signal Vpw of a pixel obtained by capturing a region not irradiated with the irradiation light (hereinafter also referred to as a non-irradiated pixel) has the same value as the pixel signal Vpb of the background image S0. This is because the background image S0 is a captured image upon applying light of the irradiation pattern P0, which is a non-irradiated pattern.

The column ADC 134A thus determines with one bit whether or not the pixel signal Vpw of the differential image S1 is smaller than the pixel signal Vpb of the background image S0, performing A/D conversion on the differential image S1. More specifically, the SAR logic circuit 1342 sets a one-bit reference signal Vdac corresponding to the pixel signal Vpb of the background image S0. The comparator 1341 compares the pixel signal Vpw of the differential image S1 with the one-bit reference signal Vdac. The SAR logic circuit 1342 outputs the one-bit (“0” or “1”) second digital signal depending on the comparison result.

In this example, the one-bit reference signal Vdac is a value obtained by including a predetermined value M as a margin in the pixel signal Vpb. As described above, the pixel signal Vpw of the non-irradiated pixel has the same value as the pixel signal Vpb of the background image S0. However, in some cases, the pixel signal Vpw of the non-irradiated pixel does not have the same value as the pixel signal Vpb of the background image S0, for example, due to a variation in ambient light or the like. The SAR logic circuit 1342 thus sets the one-bit reference signal Vdac by including a margin to the extent of preventing erroneous determination that the non-irradiated pixel is the irradiated pixel.

Moreover, the SAR logic circuit 1342 sets the one-bit reference signal Vdac in accordance with the control of the reference signal setting unit 1402 of the control unit 140. The reference signal setting unit 1402 can output the value of the one-bit reference signal Vdac or the pixel signal Vpb of the background image S0 to the SAR logic circuit 1342. In the case where the reference signal setting unit 1402 outputs the pixel signal Vpb, the SAR logic circuit 1342 sets the one-bit reference signal Vdac by including the predetermined value M to the pixel signal Vpb as a margin.

In this manner, the column ADC 134A compares the one-bit reference signal Vdac based on the pixel signal Vpb of the background image S0 with the pixel signal Vpw of the differential image S1. This configuration makes it possible for the image-capturing device 100 to determine with one bit whether each pixel of the differential image S1 is an irradiated pixel or a non-irradiated pixel.

The column ADC 134A is the SAR ADC and has the DAC 1343 individually for each column as described above, so it is possible to change the reference signal for each column. On the other hand, a single-slope integrating ADC having the DAC shared by the respective columns is difficult to change the reference signal for each column. The image-capturing device 100 according to the present embodiment uses the SAR ADC capable of changing the reference signal for each column, so enabling the A/D conversion on the differential images S1 to Sn with one bit, which results in the high-speed acquisition of the differential images S1 to Sn.

(Readout Operation)

The readout operation of the pixel signal in the image-capturing device 100 is now described. FIG. 5 is a timing chart schematically illustrating the readout of a pixel signal by the image-capturing device 100 according to the first embodiment of the present disclosure. In FIG. 5, the horizontal axis represents time, and the vertical axis represents the address (V address) of the pixel 111 to be scanned.

The image-capturing device 100 first reads out a result obtained by capturing the background image S0 in a first period T1, and then reads out the differential images S1 to Sn corresponding to a plurality of different irradiation patterns P1 to Pn in a second period T2 following the first period.

The image-capturing device 100 first reads out a pixel signal, for example, when applying light of an “all-dark” irradiation pattern, in other words, the background irradiation pattern P0 that does not apply the irradiation light in the first period T1. In this event, the image-capturing device 100 changes the reference signal (see the graph on the left side of FIG. 4) and reads out the first digital signal of 10 bits as a pixel signal.

The image-capturing device 100 then sequentially reads out pixel signals upon applying the irradiation light of the irradiation patterns P1 to Pn in the second period T2, as illustrated in FIG. 5. In the case where the irradiation light of the irradiation pattern P1 is applied following the first period T1, the image-capturing device 100 first reads out the differential image S1 corresponding to the irradiation pattern P1. In the case where the irradiation light of the irradiation pattern P2 is then applied, the image-capturing device 100 reads out the differential image S2 corresponding to the irradiation pattern P2. The image-capturing device 100 repeatedly reads out the differential images S3 to Sn until the irradiation light of the final irradiation pattern Pn is applied.

In this event, the image-capturing device 100 compares the one-bit reference signal Vdac set depending on the background image S0 with each pixel signal Vpw to read out the comparing result as the differential images S1 to Sn, as illustrated on the right side of FIG. 4. The image-capturing device 100 repeatedly reads out the captured images S0 to Sn by repeating the first and second periods T1 and T2.

In this way, reading out the differential images S1 to Sn using the one-bit reference signal Vdac by the image-capturing device 100 makes the time for the image-capturing device 100 to read out the differential images S1 to Sn shorter than the time for the image-capturing device 100 to read out the background image S0. In other words, the comparison processing for 10 bits, that is, the comparison processing for 10 times from the MSB to the LSB, is performed in the first period T1. Meanwhile, the comparison processing for one bit, that is, one-time comparison processing, is performed in the second period T2. Thus, simply considering the time for comparison processing, the processing time taken for the differential images S1 to Sn is only 1/10 of the processing time taken for the background image S0.

Thus, it is possible to make the time for the image-capturing device 100 to read out the captured images S0 to Sn that can be used for range-finding significantly shorter than the case where the image-capturing device 100 performs A/D conversion with 10 bits each time and the readout accordingly. In one example, the related art that reads out the image corresponding to the irradiation patterns P1 to Pn as the 10-bit captured image identical to the background image S0 necessitates the repetition of the comparison processing n times for 10 bits. On the other hand, the image-capturing device 100 according to the present embodiment just uses the repetition of the comparison processing n times for one bit upon reading out the differential images S1 to Sn corresponding to the irradiation patterns P1 to Pn. So, it is possible to perform the readout processing of the captured images S0 to Sn at a higher speed than the related art.

<1.3. Entire-Apparatus Control Unit of Range-Finding Apparatus>

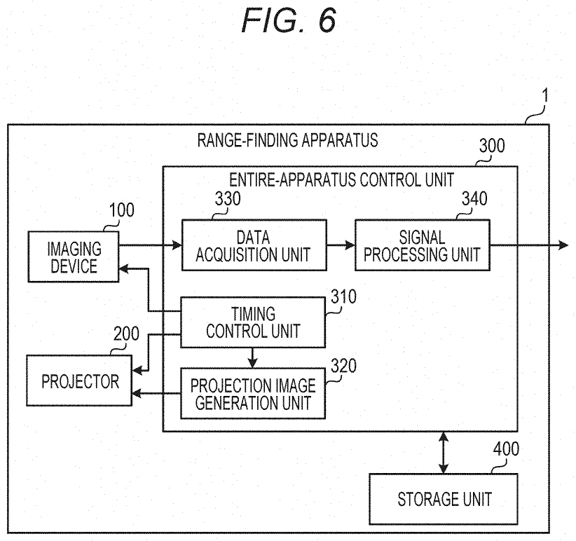

The entire-apparatus control unit 300 of the range-finding apparatus 1 according to the present embodiment is now described in detail. FIG. 6 is a block diagram illustrating an exemplary configuration of a range-finding apparatus 1 according to the first embodiment of the present disclosure.

The entire-apparatus control unit 300 is implemented by, for example, a central processing unit (CPU) or micro processing unit (MPU), or the like running a program stored in the range-finding apparatus 1 with random-access memory (RAM) or the like used as a work area. In addition, the entire-apparatus control unit 300 is a controller and can be constructed by an integrated circuit such as an application-specific integrated circuit (ASIC) or field-programmable gate array (FPGA).

The entire-apparatus control unit 300 has a timing control unit 310, a projection image generation unit 320, a data acquisition unit 330, and a signal processing unit 340, as illustrated in FIG. 6. The entire-apparatus control unit 300 achieves or executes the functions and operations of information processing described below. Moreover, the entire-apparatus control unit 300 has an internal configuration, which is not limited to that illustrated in FIG. 6. The entire-apparatus control unit 300 can be any other configuration as long as it performs information processing described later. Moreover, the entire-apparatus control unit 300 can be connected to a predetermined network by wired or wirelessly using, for example, a network interface card (NIC) to receive various types of information from an external server or the like via the network.

(Timing Control Unit)

The timing control unit 310 controls the projection image generation unit 320 so that the projection image generation unit 320 controls the irradiation pattern of the irradiation light emitted from the projector 200. In addition, the timing control unit 310 controls the projector 200 and the image-capturing device 100 to control the irradiation timing of the irradiation light by the projector 200 and the image capturing timing of the captured images S0 to Sn by the image-capturing device 100, respectively.

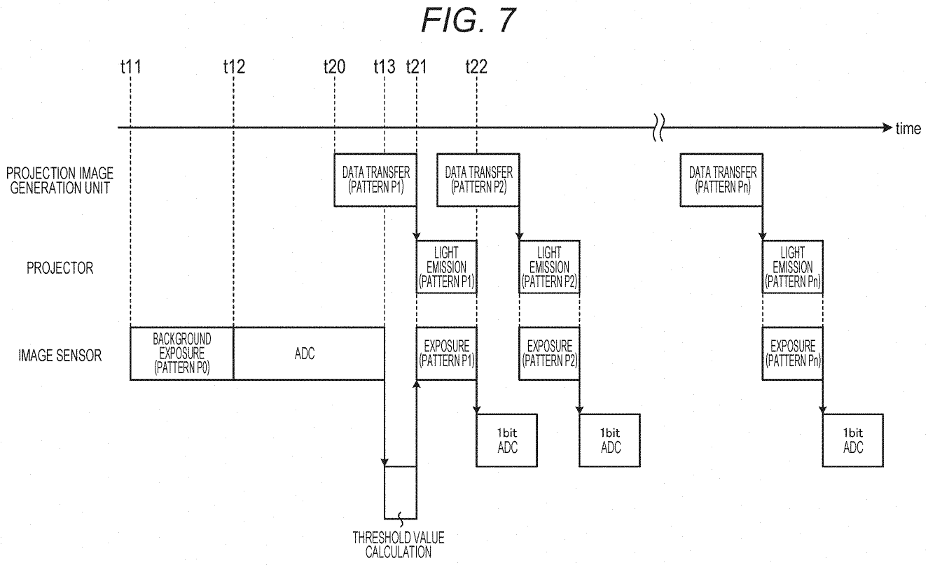

FIG. 7 is a diagram illustrated to describe an example of timing control by a timing control unit 310 according to the first embodiment of the present disclosure.

The timing control unit 310 controls the image-capturing device 100 (corresponding to an image sensor in FIG. 7) so that the image-capturing device 100 first captures the background image S0 obtained from the background irradiation pattern P0 in the example illustrated in FIG. 7. The background irradiation pattern P0 does not use light emission from the projector 200 as described above, so the projection image generation unit 320 and the projector 200 do not operate. The timing control unit 310 controls the image-capturing device 100 so that the image-capturing device 100 exposes the background light (the irradiation pattern P0) from time t11 to time t12 while the projector 200 does not emit light.

The timing control unit 310 then controls the image-capturing device 100 so that the image-capturing device 100 performs A/D conversion (ADC) on the background image S0 from time t12 to time t13. Moreover, the A/D conversion from times t12 to t13 is the multi-bit (10 bits) A/D conversion.

After performing A/D conversion on the pixel signals of all the pixels 111, the image-capturing device 100 calculates the one-bit reference signal Vdac to be used as a threshold value in the one-bit A/D conversion (1-bit ADC) at time t13.

The timing control unit 310 controls the projection image generation unit 320 at time t20 so that the projection image generation unit 320 transfers data of the following irradiation pattern (the irradiation pattern P1 in FIG. 7) to the projector 200. Moreover, as illustrated in FIG. 7, time t20 can be a time point from time t12 to time t13 when the image-capturing device 100 performs A/D conversion on the background image S0. This configuration makes it possible to decrease the image-capturing interval from the image capturing of the background image S0 by the image-capturing device 100 to the image capturing of the following differential image S1.

If the projection image generation unit 320 transfers the data of the irradiation pattern P1 to the projector 200 at time t20, the timing control unit 310 causes the projector 200 to emit light (irradiate with light) of the irradiation pattern Plat time t21. In addition, at the same timing (time t21), the timing control unit 310 causes the image-capturing device 100 to perform exposure. If the light emission and the exposure are completed at time t22, the image-capturing device 100 performs one-bit A/D conversion on the differential image S1.

Similarly, the timing control unit 310 controls the projection image generation unit 320, the projector 200, and the image-capturing device 100 so that the irradiation patterns P2 to Pn are emitted and accordingly, the differential images S2 to Sn are captured.

In this way, controlling the timing of each component by the timing control unit 310 allows the image-capturing device 100 to acquire the background image S0 in the background image acquisition phase (corresponding to the first period) and calculate a threshold value (the one-bit reference signal Vdac) of each pixel 111 used in the one-bit A/D conversion.

Further, in the differential image acquisition phase (corresponding to the second period), the projection image generation unit 320 transfers the irradiation patterns P1 to Pn, and the projector 200 emits light of the transferred irradiation pattern in a relatively short time. The image-capturing device 100 exposes the image in accordance with the light emission timing of the projector 200, performs one-bit A/D conversion upon completion of the exposure, and outputs the differential images S1 to Sn.

Moreover, in FIG. 7, the irradiation pattern Pn is the projection image with predetermined stripes, and the projection image generation unit 320 transfers the data of the irradiation pattern Pn to the projector 200, but such a configuration is not limited to this exemplary arrangement. In one example, the irradiation pattern Pn can be the same non-irradiated pattern as the background irradiation pattern P0. In this case, the data transfer of the irradiation pattern Pn by the projection image generation unit 320 and the light emission of the irradiation pattern Pn by the projector 200 can be omitted. The timing control unit 310 controls the image-capturing device 100 so that the image-capturing device 100 performs the exposure while the projector 200 does not emit light. Moreover, in this case, the differential image Sn is used to set a confidence coefficient in the distance calculation. Setting the confidence coefficient is described later.

(Projection Image Generation Unit)

Referring again to FIG. 6, the projection image generation unit 320 transfers, for example, the data of the irradiation pattern stored in the storage unit 400 to the projector 200 in accordance with the control of the timing control unit 310. The description is now given for a case of using the irradiation pattern disclosed in Non-Patent Document 1 as the projection image (irradiation pattern) generated by the projection image generation unit 320.

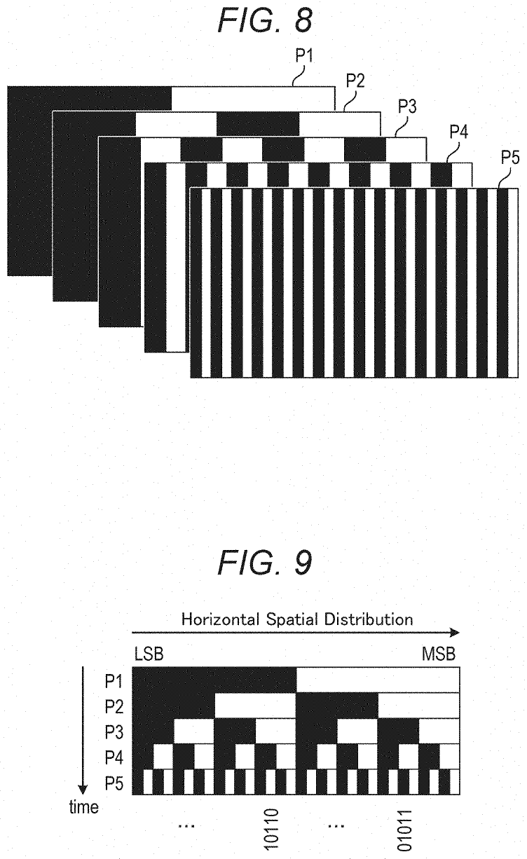

FIGS. 8 and 9 are diagrams illustrated to describe an example of an irradiation pattern transferred by a projection image generation unit 320 according to the first embodiment of the present disclosure.

The projection image generation unit 320 transfers the irradiation patterns P1 to Pn−1 to the projector 200. In FIG. 8, the projection image generation unit 320 transfers the irradiation patterns P1 to P5 to the projector 200.

The irradiation pattern P1 is a two-color pattern image with black (dark) on the left side and white (bright) on the right side, as illustrated in FIG. 8. The irradiation pattern P2 is a pattern in which two black vertical stripes and two white vertical stripes are alternately arranged one by one. An irradiation pattern Pm is a pattern in which 2^{(m-1)} black vertical stripes and 2^{(m-1)} white vertical stripes are alternately arranged one by one.

The irradiation patterns P1 to Pn−1 are binary-coded pattern images in this way. The irradiation patterns P1 to Pn are coded as “00000”, “00001”, and so on in order from the left side of the pattern image if the black stripes are “0” and the white stripes are “1”, as illustrated in FIG. 9. Moreover, the irradiation patterns P1 to Pn−1 are arranged vertically in FIG. 9. In FIG. 9, the downward arrow represents the time, and the horizontal arrow represents the black and white horizontal spatial distribution. In FIG. 9, the left side is the least significant bit (LSB), and the right side is the most significant bit (MSB).

In this way, the binary code is associated with each stripe in the horizontal direction of each irradiation pattern. In other words, the irradiation pattern can be binary-coded for each irradiation angle of light by the projector 200 in the horizontal direction.

The projection image generation unit 320 is herein intended to transfer the data of the irradiation pattern identical to the background irradiation pattern P0, for example, as the last irradiation pattern Pn. In this case, the irradiation patterns P0 and Pn are all black shading patterns (projection images). In this instance, the differential image Sn corresponding to the irradiation pattern Pn is used to set a confidence coefficient by the signal processing unit 340. The setting of the confidence coefficient is described later in detail.

Moreover, the irradiation patterns illustrated in FIGS. 8 and 9 are examples, and the patterns are not limited to the illustrated ones. Any pattern can be used as long as it is a pattern in which binary coding is subjected so that the pixels corresponding to the captured images S0 to Sn are identifiable. In one example, a light-dark pattern of horizontal stripes, rather than vertical stripes, can be used.

(Data Acquisition Unit)

Referring again to FIG. 6, the data acquisition unit 330 acquires the background image S0 and the differential images S1 to Sn captured by the image-capturing device 100. The data acquisition unit 330 acquires the background image S0 and the differential images S1 to Sn and acquires information regarding the timing (frame ID) at which each image is captured. The data acquisition unit 330 outputs the acquired background image S0, differential images S1 to Sn, and timing information to the signal processing unit 340. The data acquisition unit 330 can function as, for example, a frame buffer for storing the background image S0 and the differential images S1 to Sn.

(Signal Processing Unit)

The signal processing unit 340 calculates the distance (depth) to the to-be-measured object ob and the confidence coefficient for the distance, on the basis of the captured images S0 to Sn acquired by the data acquisition unit 330 and information regarding calibration. The calibration information is, for example, information corresponding to the optical system and the geometric position of the image-capturing device 100 and the projector 200, and is information acquired in advance by calibration. The calibration information can be stored in advance, for example, in the storage unit 400.

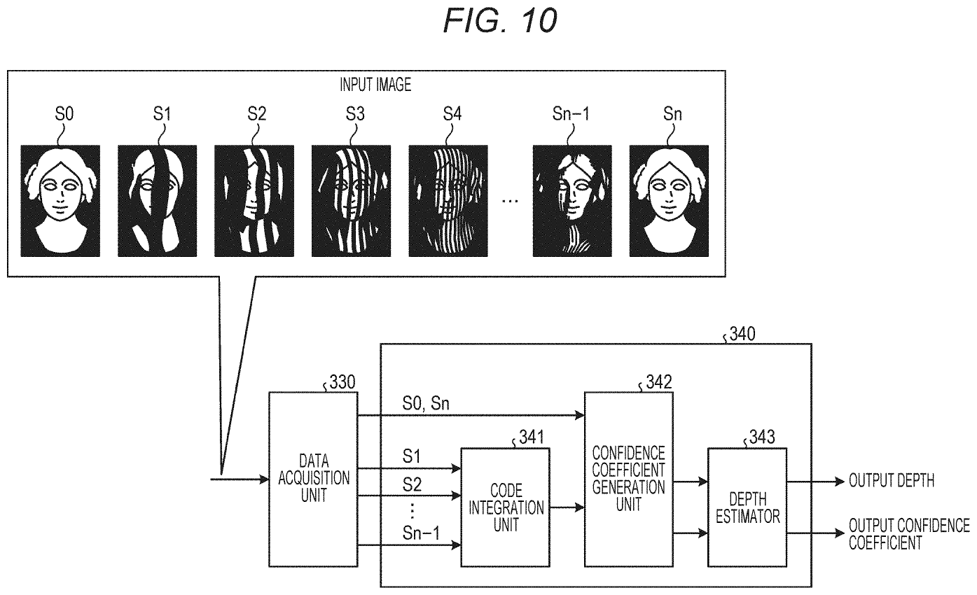

FIG. 10 is a block diagram illustrating an exemplary configuration of a signal processing unit 340 according to the first embodiment of the present disclosure. The signal processing unit 340 includes a code integration unit 341, a confidence coefficient generation unit 342, and a depth estimator 343.

The data acquisition unit 330, when acquiring the captured images S0 to Sn as an input image from the image-capturing device 100, outputs the captured image S0, which is the background image, and the differential image Sn to the confidence coefficient generation unit 342, as illustrated in FIG. 10. In addition, the data acquisition unit 330 outputs the differential images S1 to Sn−1 to the code integration unit 341.

(Code Integration Unit)

The code integration unit 341 integrates values of the respective pixels of the differential images S1 to Sn−1 into one code. Each pixel of the differential image S1 to Sn−1 is subjected to one-bit A/D conversion by the image-capturing device 100, and the irradiation pixel is represented by “1”, and the non-irradiated pixel is represented by “0”. Thus, for example, in the case where all the corresponding pixels of the differential images S1 to Sn−1 are non-irradiated pixels, the code integration unit 341 integrates values of the pixels into “00 . . . 0”. The code integration unit 341 can be a generation unit that integrates the differential images S1 to Sn−1 to generate an image with a pixel value of an n−1 bit (hereinafter also referred to as an integrated image).

Moreover, in the range-finding apparatus of the related art, an image-capturing device outputs a captured image with a pixel value of 10 bits as a captured image corresponding to a predetermined irradiation pattern. Thus, a code integration unit in the related art needs to determine whether each pixel of the captured image is an irradiation pixel or a non-irradiated one using a threshold value.

However, the image-capturing device 100 according to the present embodiment determines whether each pixel of the captured image is an irradiation pixel or a non-irradiated one by a threshold value (one-bit reference signal) and outputs the result as the differential images S1 to Sn−1. Thus, the threshold value processing on the captured images S1 to Sn−1 can be omitted in the code integration unit 341 according to the present embodiment, and the code integration is sufficient.

(Confidence Coefficient Generation Unit)

The confidence coefficient generation unit 342 calculates a confidence coefficient of each pixel of the integrated image generated by the code integration unit 341. In the range-finding apparatus of the related art, a code integration unit determines whether each pixel is bright or dark by a threshold value, as described above. Thus, if the determination with a threshold value is difficult for a pixel having a pixel value approximating the threshold value, the code integration unit lowers the level of the confidence coefficient of the pixel to prevent the depth calculation from being indeterminate.

On the other hand, in the present embodiment, the image-capturing device 100 determines whether each pixel is bright or dark by a threshold value (one-bit A/D conversion), and the code integration unit 341 does not perform such determination. Thus, in the present embodiment, the confidence coefficient generation unit 342 is intended to calculate the confidence coefficient of each pixel on the basis of the captured images S0 to Sn. Moreover, the confidence coefficient generation unit 342 outputs the integrated image generated by the code integration unit 341 and the calculated confidence coefficient to the depth estimator 343.

(First Example of Confidence Coefficient Calculation)

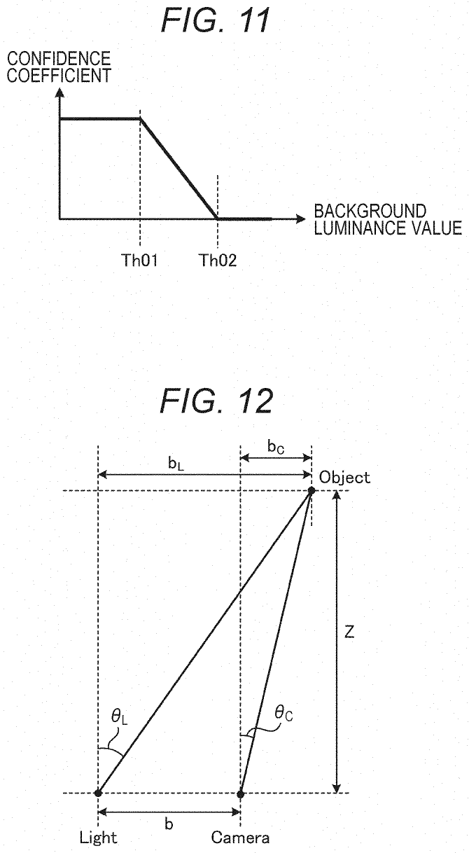

FIG. 11 is a diagram illustrated to describe confidence coefficient calculation by a confidence coefficient generation unit 342 according to the first embodiment of the present disclosure. The confidence coefficient generation unit 342 calculates a confidence coefficient of each pixel of the integrated image depending on the luminance value of the background image S0.

The background irradiation pattern P0 upon capturing the background image S0 is a non-irradiated pattern that does not apply light. However, in some cases, the electric charge accumulated in the pixel 111 is saturated even for the non-irradiated pattern, for example, if the ambient light is strong. In such a case, the image-capturing device 100 fails to determine in a normal manner whether or not the irradiation light is applied during the subsequent differential images S1 to Sn, in other words, the presence or absence of pattern irradiation.

Thus, the confidence coefficient generation unit 342 compares a luminance value of each pixel of the background image S0 (hereinafter also referred to as a background luminance value) with a threshold value and calculates the confidence coefficient depending on the comparison result. More specifically, the confidence coefficient generation unit 342 sets the confidence coefficient in such a way as to lower the confidence coefficient value as the background luminance value is closer to luminance value upon the electric charge saturation (hereinafter also referred to as a saturation value). In one example, in a case where the background luminance value is a first threshold value Th01 or more and less than a second threshold value Th02 in the example of FIG. 11, the confidence coefficient generation unit 342 sets the confidence coefficient value of the relevant pixel to decrease as the background luminance value increases. In a case where the background luminance value is the second threshold value Th02 or more, the confidence coefficient generation unit 342 sets the confidence coefficient value to the lowest value (e.g., zero). Moreover, the second threshold value Th02 is preferably set to a value approximating the saturation value.

(Second Example of Confidence Coefficient Calculation)

The description is now given of another example in which the confidence coefficient generation unit 342 calculates the confidence coefficient. Even if the projector 200 emits light, the brightness of the reflected light on the to-be-measured object ob is smaller as the distance from the projector 200 to the to-be-measured object ob is longer. Thus, even if the projector 200 is located to emit light, in some cases, the pixel signal does not exceed the threshold value (one-bit reference signal) of the column ADC 134A, and the result of one-bit A/D conversion is “0” (dark).

Thus, in a case where the luminance values of respective pixels of the differential images S1 to Sn−1 are “0” for all of the differential images S1 to Sn−1, the confidence coefficient generation unit 342 sets the confidence coefficient value of the relevant pixel to the lowest value (e.g., zero). In this case, the projection image generation unit 320 can apply the light of, for example, an all-white irradiation pattern (whole irradiation pattern) as one of the irradiation patterns P1 to Pn−1.

(Third Example of Confidence Coefficient Calculation)

The image-capturing device 100 according to the present embodiment is capable of capturing the captured images S0 to Sn at high speed. Thus, it is possible for the range-finding apparatus 1 to calculate the distance to the to-be-measured object ob with higher precision even if the to-be-measured object ob moves to some extent. However, for example, if the to-be-measured object ob moves at high speed, in some cases, the distance calculation (sensing) will fail. Thus, the confidence coefficient generation unit 342 sets the confidence coefficient of a position (pixel) where the to-be-measured object ob has moved significantly to be a low value.

As described above, the irradiation pattern Pn is the same irradiation pattern as the background (non-irradiated) irradiation pattern P0. Thus, in a case where there is no change in the to-be-measured object ob upon applying light of the background irradiation pattern P0 and the upon applying light of the irradiation pattern Pn, the luminance values of respective pixels of the differential image Sn are all “0”. On the other hand, if there is a change in motion of the to-be-measured object ob, such as when the to-be-measured object ob moves, the luminance value of the position where the differential image Sn has changed is switched into “1”. Thus, the confidence coefficient generation unit 342 sets the confidence coefficient of the pixel with the luminance value of the differential image Sn of “1” to be a low value, for example, the lowest value (zero).

Moreover, the confidence coefficient generation unit 342 can calculate the confidence coefficients described in the first to third confidence coefficient calculation examples individually for each pixel or calculate one confidence coefficient for each pixel. In the case of calculating one confidence coefficient for each pixel, a value of one of the first to third confidence coefficient calculation examples can be calculated. Alternatively, one confidence coefficient can be calculated for each pixel by adding values calculated by the first to third confidence coefficient calculation examples.

Further, the confidence coefficient calculation examples described above are illustrative, and the confidence coefficient generation unit 342 can calculate the confidence coefficient using a method other than the confidence coefficient calculation examples described earlier.

(Depth Estimator)

Referring again to FIG. 10, the depth estimator 343 estimates the distance (depth) to the to-be-measured object ob on the basis of the integrated image. As described above, the irradiation patterns P1 to Pn−1 of the projector 200 are binary coded for each irradiation angle. Thus, the depth estimator 343 is capable of associating each pixel with the irradiation angle of the projector 200 by decoding each pixel value of the integrated image.

The depth estimator 343 uses the irradiation angle of the projector 200 for each pixel and an internal or external parameter of the image-capturing device 100 to acquire the distance (depth information) to the to-be-measured object ob. The internal or external parameter is acquired in advance by calibration (corresponding to the calibration information mentioned above).

As illustrated in FIG. 12, an irradiation angle when the projector 200 (corresponding to Light in FIG. 12) irradiates the to-be-measured object ob (corresponding to Object in FIG. 12) is given to θ_{L}. An observation angle when the to-be-measured object ob is viewed from the image-capturing device 100 (corresponding to Camera in FIG. 12) is given to θ_{C}. Given that a distance b from the projector 200 to the image-capturing device 100 is used as the calibration information, the depth estimator 343 calculates a depth Z using Formula (1) as below.

$$\begin{matrix}[ Math . 1 ] & \\ Z = \frac{b}{tan ( {θ}_{l} ) - tan ( {θ}_{C} )} & ( 1 )\end{matrix}$$

Note that FIG. 12 is a diagram illustrated to describe a way to calculate a depth by a depth estimator 343 according to the first embodiment of the present disclosure.

Referring again to FIG. 10, the depth estimator 343 outputs calculated depth Z as an output depth. In addition, the depth estimator 343 outputs the confidence coefficient set by the confidence coefficient generation unit 342 as an output confidence coefficient in association with the calculated depth Z.

<1.4. Exemplary Operation of Range-Finding Apparatus>

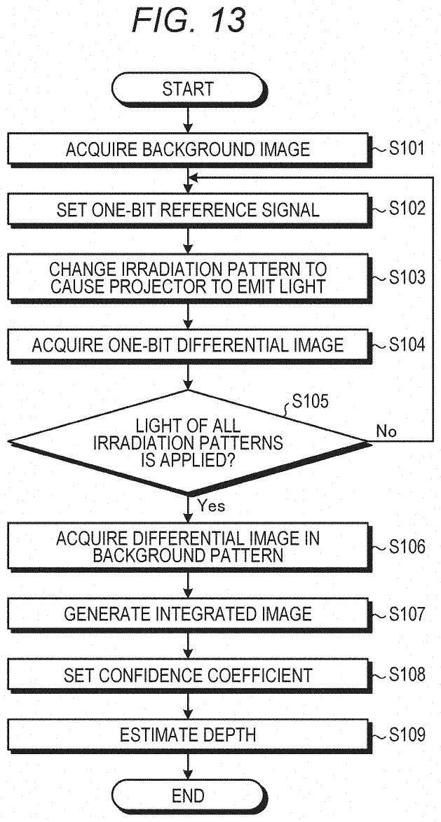

FIG. 13 is a flowchart illustrating an exemplary schematic operation of the range-finding apparatus 1 according to the first embodiment of the present disclosure. Moreover, the range-finding apparatus 1 can repeatedly execute the operation illustrated in FIG. 13 while measuring the distance to the to-be-measured object ob.

As illustrated in FIG. 13, the range-finding apparatus 1 acquires the background image S0 (step S101). More specifically, the range-finding apparatus 1 acquires the background image S0 having a luminance value of 10 bits with a background irradiation pattern P0 that does not use light emission from the projector 200.

The range-finding apparatus 1 then sets the one-bit reference signal Vdac as the reference signal of the column ADC 134A of the image-capturing device 100 on the basis of the acquired background image S0 (step S102).

The range-finding apparatus 1 changes the irradiation pattern to cause the projector 200 to emit light (step S103) and then acquires a one-bit differential image (step S104). The range-finding apparatus 1 determines whether or not the light of all the irradiation patterns of the irradiation patterns P1 to Pn−1 is applied (step S105). If the light of all the irradiation patterns is not applied (No in step S105), the processing returns to step S103.

If the light of all the irradiation patterns is applied (Yes in step S105), the range-finding apparatus 1 acquires the differential image Sn in the same irradiation pattern Pn (background pattern) as the background image S0 (step S106).

The range-finding apparatus 1 integrates the acquired differential images S1 to Sn−1 to generate an integrated image (step S107). The range-finding apparatus 1 then sets the confidence coefficient of each pixel on the basis of the captured images S0 to Sn (step S108). The range-finding apparatus 1 estimates the depth of each pixel on the basis of the integrated image (step S109).

As described above, the range-finding apparatus 1 according to the present embodiment acquires the background image S0 and then acquires the one-bit differential images S1 to Sn. Thus, it is possible for the range-finding apparatus 1 to significantly shorten the time for acquiring the captured image used for the distance calculation.

In one example, given that the time of a frame rate of 120 frames per second (FPS) is used to acquire a 10-bit captured image. In addition, given that the range-finding apparatus 1 acquires 10 pieces of captured images in addition to the background for calculating the distance.

In this case, in the range-finding apparatus of the related art, if it intends to acquire a 10-bit captured image as a captured image other than the background, it is used to acquire a total of 11 pieces of captured images including the background image, accordingly taking time at a frame rate of 11 FPS. Thus, the to-be-measured object ob or the image-capturing device is more likely to move from when the range-finding apparatus of the related art first acquires the background image to when it acquires the last captured image, which makes the higher precision calculation of distance difficult. In addition, the range-finding apparatus of the related art takes a relatively long time to acquire the captured image, which makes the time for distance calculation difficult to shorten.

On the other hand, the range-finding apparatus 1 according to the present embodiment acquires the background image S0 and then acquires the one-bit differential images S1 to Sn as described above. This configuration makes it possible to shorten the time for acquiring images other than the background image to about one-tenth (e.g., about 1059 FPS). Thus, even if a total of 11 pieces of captured images including the background image are acquired, the range-finding apparatus 1 is capable of acquiring them in a time of a frame rate of 60 FPS. Thus, the to-be-measured object ob or the image-capturing device 100 is less likely to move from when the range-finding apparatus 1 first acquires the background image to when it acquires the last captured image, making the higher precision calculation of distance easy. In addition, it is possible to significantly shorten the time taken for the range-finding apparatus 1 to calculate the distance.

### 2. Second Embodiment

According to the first embodiment, the description above is given for the case the range-finding apparatus 1 measures the distance to the to-be-measured object ob. Besides the above example, the range-finding apparatus 1 can acquire an RGB captured image in addition to the distance measurement. Thus, according to a second embodiment, the description is given for an example in which the range-finding apparatus 1 acquires an RGB captured image in addition to measuring the distance to the to-be-measured object ob.

FIG. 14 is a diagram illustrating the exemplary arrangement of the pixels 111 of the image-capturing device 100 according to the second embodiment of the present disclosure. As illustrated in FIG. 14, the pixels 111 of the image-capturing device 100 according to the present embodiment include a normal pixel and an infrared (IR) pixel. The normal pixel receives R (red), G (green), and B (blue) light. The infrared pixel receives, for example, infrared (IR) light.

The normal pixel includes one color filter of R, G, and B filters stacked on the light-receiving surface of a photoelectric transducer (not illustrated). The normal pixels configure, for example, a Bayer array in the pixel array section 110. The description below is given that a normal pixel with a G filter stacked is referred to as a pixel G, a normal pixel with an R filter stacked is referred to as a pixel R, and a normal pixel with a B filter stacked is referred to as a pixel B.

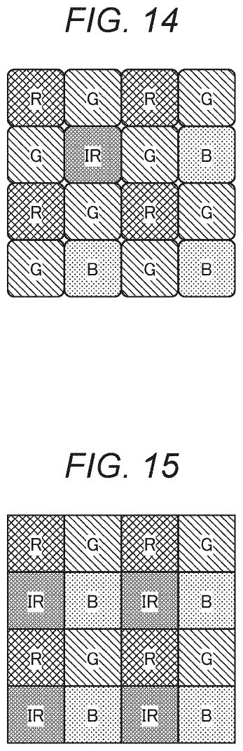

The infrared pixel has an infrared filter stacked on the light-receiving surface of the photoelectric transducer. The infrared filter is capable of receiving infrared, that is, light with a wavelength in the infrared region. The Infrared pixels are arranged in a predetermined pixel row at predetermined intervals. In one example, the infrared pixels are arranged alternately with G pixels in a predetermined pixel row. Alternatively, as illustrated in FIG. 15, they can be sequentially arranged at a position corresponding to the pixel G of the Bayer array of normal pixels in a predetermined pixel row and adjacent to the pixel B in the same row. Moreover, FIG. 15 is a diagram illustrating another exemplary arrangement of the pixel 111 of the image-capturing device 100 according to the second embodiment of the present disclosure.

In this manner, the image-capturing device 100 according to the present embodiment has the normal pixel for capturing an RGB image and the infrared pixel for capturing an image for distance measurement. Moreover, the projector 200 is intended to emit infrared light as irradiation light in the present embodiment.

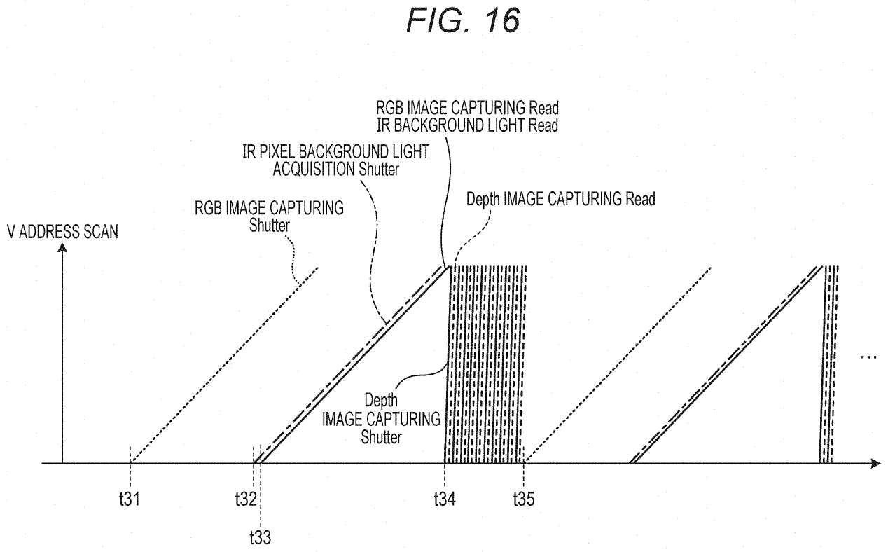

The readout operation of the pixel signal in the image-capturing device 100 according to the present embodiment is now described. FIG. 16 is a timing chart schematically illustrating the readout of a pixel signal by the image-capturing device 100 according to the second embodiment of the present disclosure. In FIG. 16, the horizontal axis represents time, and the vertical axis represents the address in the vertical direction (V address) of the pixel 111 to be scanned.

The image-capturing device 100 according to the present embodiment captures the RGB captured images and then captures the captured images S0 to Sn for depth calculation.

As illustrated in FIG. 16, the image-capturing device 100 first initiates exposure for RGB image capturing (RGB image capturing shutter) at time t31. In other words, the image-capturing device 100 initiates the exposure of normal pixels. The image-capturing device 100 then initiates exposure for background image capturing for depth calculation (IR image background light acquisition shutter) at time t32. In other words, the image-capturing device 100 initiates exposure of the infrared pixel.

The image-capturing device 100 executes readout of normal pixels (RGB image read) and readout of infrared pixels (IR background light read) at time t33.

In this event, the image-capturing device 100 acquires an offset component or P-phase signal component and a correlated double sampling (CDS) due to variation in the characteristics of the pixel 111 or the column ADC 134A, for example, during the RGB image capturing with normal pixels. The image-capturing device 100 then deducts a signal component upon the image capturing for depth calculation by the infrared pixel by the exposure time of the image capturing and at the same time, adds the offset component acquired in the RGB image capturing to the signal component to acquire the background image S0 The image-capturing device 100 compresses the acquired background image S0 bit by bit and stores it in the frame memory 1403 (see FIG. 3) frame by frame.

The image-capturing device 100 executes the exposure at a predetermined irradiation pattern (depth image capturing shutter) and readout of the one-bit differential images S1 to Sn (depth image capturing read) to acquire the differential images S1 to Sn used for the depth calculation at the time t34. Such exposure and readout are repeated at time t35 until the subsequent exposure for RGB image capturing is started. Following the time t35, the capturing of RGB images and the capturing of the captured images S1 to Sn for depth calculation are repeatedly in a similar way to that following the time t31.

As described above, the image-capturing device 100 is capable of outputting the captured images S0 to Sn for depth calculation at high speed. Thus, the RGB image and the captured images S0 to Sn for depth calculation can be captured by the same image-capturing device 100.

Moreover, the description is herein given for the case where the image-capturing device 100 captures the RGB image and the captured images S0 to Sn for depth calculation in order, but the configuration of the present embodiment is not limited to the example illustrated. In one example, the image-capturing device 100 can simultaneously capture the RGB image and the captured images S0 to Sn for depth calculation. This configuration is described with reference to FIG. 17. FIG. 17 is a diagram illustrated to describe another example of the image-capturing timing of the image-capturing device 100 according to the second embodiment of the present disclosure.

As illustrated in FIG. 17, the image-capturing device 100 captures the RGB image with normal pixels and captures images S0 to Sn for depth calculation with infrared pixels (where n=8 in FIG. 17) in parallel with capturing the RGB image. In other words, the image-capturing device 100 acquires the RGB image in a fourth period in which a first period for acquiring the background image S0 and a second period for acquiring the differential images S1 to S8 are combined.

The image-capturing device 100 captures the initial background image S0 with 10 bits in the image capturing by the infrared pixel. The capturing of the RGB image is executed in a similar sequence to the capturing of the background image S0. After the background image S0 is captured, the differential images S1 to S8 are captured with one bit (light-and-dark determination by a threshold value). The image-capturing device 100 repeatedly performs the capturing of the RGB image and the capturing of the captured images S0 to S8 for depth calculation, for example, every 1/30 second.

In this way, the image-capturing device 100 simultaneously captures the RGB image and the captured images S0 to Sn for depth calculation, which makes it possible to acquire the RGB image and the depth information simultaneously in the same frame.

### 3. Third Embodiment

The first embodiment described above illustrates the case where the one-bit reference signal Vdac (threshold value) is set simultaneously for all the pixels 111 on the basis of the pixel signal of the background image S0. Besides the above example, the one-bit reference signal Vdac can be set on the basis of the pixel signals of adjacent pixels 111. Thus, a third embodiment describes a case where the image-capturing device 100 sets the one-bit reference signal Vdac on the basis of the pixel signals of the adjacent pixels 111.

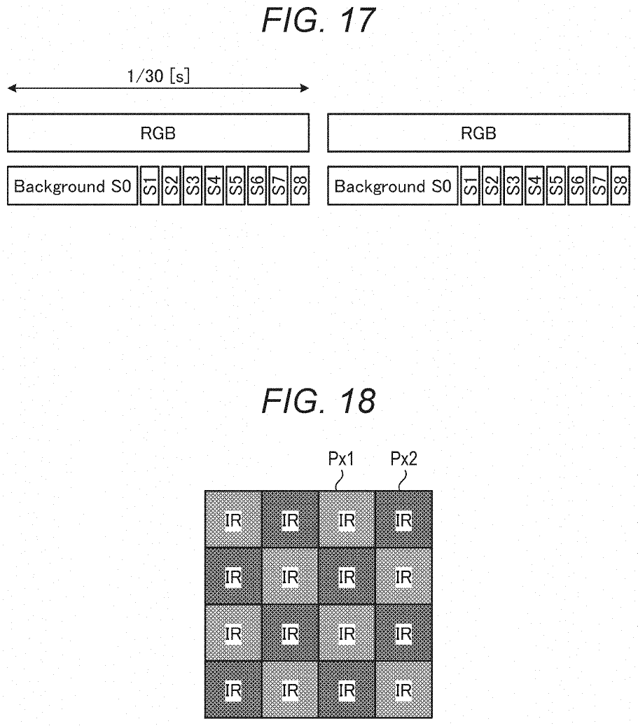

Moreover, the present embodiment describes that the pixels 111 of the image-capturing device 100 are all infrared pixels, as illustrated in FIG. 18. In addition, two adjacent pixels are now referred to as a first pixel Px1 and a second pixel Px2. Moreover, FIG. 18 is a diagram illustrating the exemplary arrangement of the pixels 111 of the image-capturing device 100 according to the third embodiment of the present disclosure.

As illustrated in FIG. 18, the first pixel Px1 and the second pixel Px2 are arranged in a checkered pattern. In other words, the first pixels Px1 are arranged so as not to be adjacent to each other, and the second pixels Px2 are arranged so as not to be adjacent to each other. This configuration allows substantially the same image to be considered to be acquired from adjacent first pixel Px1 and second pixel Px2.

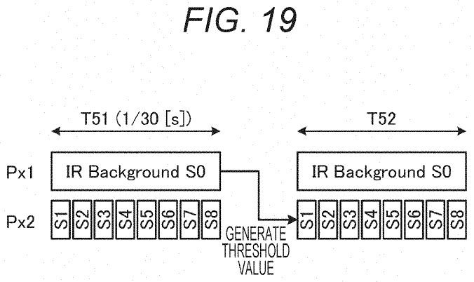

FIG. 19 is a diagram illustrated to describe an example of the image-capturing timing of the image-capturing device 100 according to the third embodiment of the present disclosure.

As illustrated in FIG. 19, the image-capturing device 100 captures the background image S0 with the first pixel Px1 and captures the differential images S1 to Sn (where n=8 in FIG. 19) with the second pixel Px2 in the period T51. The image-capturing device 100, when completing the capturing of the background image S0 on the first pixel Px1, sets the one-bit reference signal Vdac (threshold value) corresponding to the second pixel Px2 on the basis of the pixel signal on the first pixel Px1.

The image-capturing device 100, in the next period T52, captures the background image S0 with the first pixel Px1 and captures the differential images S1 to S8 with the second pixel Px2 using the one-bit reference signal Vdac set between periods T51 and T52.

In this manner, the image-capturing device 100 separately captures the first pixel Px1 for capturing the background image and the second pixel Px2 for capturing the differential image, capturing each image. In other words, the first pixel Px1 is a pixel for capturing the background image S0, and the second pixel Px2 is a pixel for capturing the differential images S1 to S8. The image-capturing device 100 sets the one-bit reference signal Vdac corresponding to the second pixel Px2 adjacent to the first pixel Px1 on the basis of the pixel signal of the first pixel Px1. The image-capturing device 100 configures the adjacent first pixel Px1 and second pixel Px2 to be a set and calculates the depth information for each set.

This configuration makes it possible to make the acquisition time of the differential images S1 to Sn used for the distance calculation shorter, approximately half, than the case of acquiring the background image S0 and the differential images S1 to Sn with the same pixel.

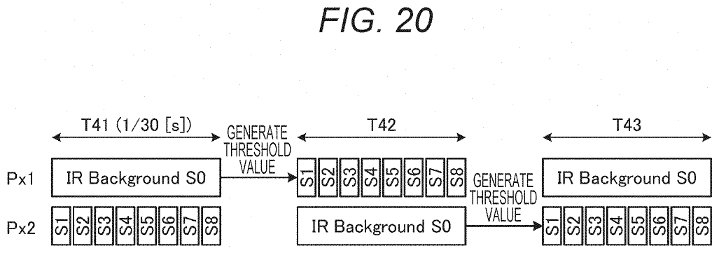

Moreover, setting the one-bit reference signal Vdac in FIG. 20 is performed on the basis of the pixel signals of the adjacent pixels 111. However, besides the above example, the timing of setting the one-bit reference signal Vdac can be different for the adjacent first and second pixels Px1 and Px2.

As illustrated in FIG. 20, the image-capturing device 100 captures the background image with the first pixel Px1 and captures the differential images with the second pixel Px2 in the period 141. The image-capturing device 100, when completing the capturing of the background image on the first pixel Px1, sets the one-bit reference signal Vdac (threshold value) corresponding to the first pixel Px1.

The image-capturing device 100, in the next period T42, captures the differential images using the set one-bit reference signal Vdac with the first pixel Px1, and captures the background image with the second pixel Px2. The image-capturing device 100, when completing the capturing of the background image on the second pixel Px2, sets the one-bit reference signal Vdac (threshold value) corresponding to the second pixel Px2. The image-capturing device 100, in the next period 143, captures the background image with the first pixel Px1 and, with the second pixel Px2, captures the differential images using the set one-bit reference signal Vdac.

Note that FIG. 20 is a diagram illustrated to describe another example of the image-capturing timing of the image-capturing device 100 according to the third embodiment of the present disclosure.

In this manner, the image-capturing device 100 according to the present embodiment makes the timings of setting the one-bit reference signal Vdac for the adjacent first and second pixels Px1 and Px2 different. This configuration enables the image-capturing device 100 to make the image capturing time shorter than the case where the timings for setting the one-bit reference signal Vdac at the same timing are identical.

Moreover, in the examples of FIGS. 19 and 20, the projector 200 applies the light of the background irradiation pattern P0 at the beginning of each period and then applies the light of the irradiation patterns P1 to Pn. In other words, the image-capturing device 100 performs the exposure in synchronization with applying the light of the background irradiation pattern P0 and then performs the 10-bit A/D conversion. However, the image-capturing device 100 performs the exposure and the one-bit A/D conversion in synchronization with the irradiation patterns P1 to Pn in parallel with the 10-bit A/D conversion. This configuration allows the acquisition time of the captured images S0 to Sn to be shorter than the case where the 10-bit A/D conversion and the one-bit A/D conversion are performed in different first and second periods.

### 4. Fourth Embodiment

The first embodiment illustrates the case where the range-finding apparatus 1 sets the confidence coefficient on the basis of the differential image Sn corresponding to the irradiation pattern Pn that is the same irradiation pattern as the background irradiation pattern P0. Besides the above example, the range-finding apparatus 1 can set the confidence coefficient on the basis of the difference between the background images S0. Thus, a fourth embodiment describes an example in which the range-finding apparatus 1 sets the confidence coefficient on the basis of the difference between the background images S0.

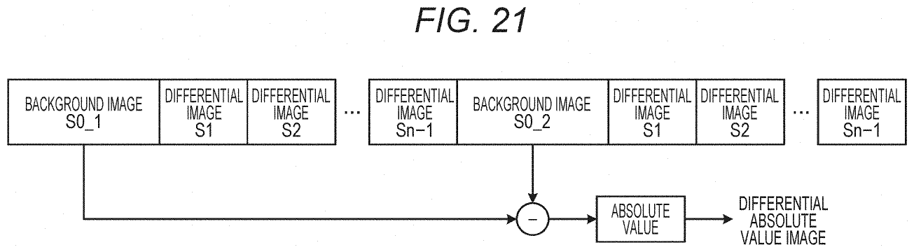

FIG. 21 is a diagram illustrated to describe confidence coefficient calculation by a confidence coefficient generation unit 342 according to a fourth embodiment of the present disclosure.

As illustrated in FIG. 21, the image-capturing device 100 repeatedly captures the background image S0 and the differential images S1 to Sn−1. Moreover, in the present embodiment, the range-finding apparatus 1 can omit the irradiation of the irradiation pattern Pn and the capturing of the differential image Sn.

In this case, the confidence coefficient generation unit 342 calculates a difference between a background image S0_1 acquired at the one previous timing and a background image S0_2 acquired at present. The confidence coefficient generation unit 342 calculates a differential absolute value image in which the absolute value of the difference is the pixel value (differential absolute value luminance) of each pixel.

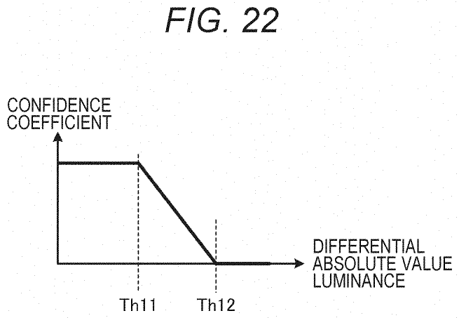

The confidence coefficient generation unit 342 determines the calculated differential absolute value luminance as a threshold value and sets the confidence coefficient depending on the determination result. FIG. 22 is a diagram illustrated to describe the calculation of a confidence coefficient by the confidence coefficient generation unit 342 according to the fourth embodiment of the present disclosure. As illustrated in FIG. 22, if the differential absolute value luminance is equal to or more than a third threshold value Th11 and less than a fourth threshold value Th12, the confidence coefficient generation unit 342 sets the confidence coefficient in such a way that the confidence coefficient decreases as the differential absolute value luminance increases. In addition, if the differential absolute value luminance is the fourth threshold value Th12 or more, the confidence coefficient generation unit 342 is set so that the confidence coefficient is the lowest (e.g., the confidence coefficient is zero).

In this way, the confidence coefficient generation unit 342 determines whether or not there is a change in motion of the to-be-measured object ob on the basis of the difference between the background images S0 and sets the confidence coefficient depending on the determination result.

### 5. Other Embodiments

In the first to fourth embodiments described above, the light of the same irradiation pattern as the background irradiation pattern P0 is applied once at the end of the plurality of irradiation patterns P1 to Pn. In other words, the irradiation pattern Pn is the same irradiation pattern as the background irradiation pattern P0. However, the light of the same irradiation pattern as the background irradiation pattern P0 is not necessarily applied in the last, or the light of the irradiation pattern can be applied a plurality of times. In one example, the light of the same irradiation pattern as the background pattern among multiple irradiation patterns P1 to Pn can be applied every predetermined number of times. This configuration makes it possible to detect in more detail whether or not the to-be-measured object ob has moved at high speed, improving the accuracy of confidence coefficient calculation by the confidence coefficient generation unit 342.

Further, in the first to fourth embodiments described above, the control unit 140 of the image-capturing device 100 causes the bit-compressed background image S0 to be stored in the frame memory 1403, but such a configuration is not limited to the above example. In one example, the control unit 140 can cause the value of the one-bit reference signal Vdac set for each pixel to be stored in the frame memory 1403. In this case, the reference signal setting unit 1402 of the control unit 140 outputs the one-bit reference signal Vdac stored in the frame memory 1403 to the SAR logic circuit 1342.

Further, in the first to fourth embodiments described above, the background irradiation pattern P0 is a non-irradiation (all black) irradiation pattern, but such a configuration is not limited to the above example. The background irradiation pattern P0 can be any specified irradiation pattern and can be, for example, a whole all-white irradiation pattern. In this case, the last irradiation pattern Pn is the same irradiation pattern as the background irradiation pattern P0, so it is a whole irradiation pattern.

Further, in the first to fourth embodiments described above, the timing control unit 310 of the range-finding apparatus 1 controls the image-capturing timing of the image-capturing device 100, the projection timing of the projector 200, and the like. However, such a configuration is not limited to the above example. In one example, the image-capturing device 100 can be provided with the timing control unit 310. In this case, the timing control unit 310 generates a control signal for controlling the timing of each component and outputs the control signal to the outside of the image-capturing device 100.

### 6. Supplement

The preferred embodiment of the present disclosure has been described above with reference to the accompanying drawings, whilst the present disclosure is not limited to the above examples. A person skilled in the art may find various alterations and modifications within the scope of the appended claims, and it should be understood that they will naturally come under the technical scope of the present disclosure.

The processes described in the above respective embodiments, the entirety or a part of the processes described as being automatically performed can be manually performed, or the entirety or a part of the processes described as being performed manually can be performed automatically using known methods. In addition, the details or information including processing procedures, specific names, various data, or various parameters indicated in the documents mentioned above and the drawings can be optionally modified unless otherwise specified. In one example, the various types of information illustrated in each figure are not limited to the illustrated information.

Further, the components of respective apparatuses or devices illustrated are functionally conceptual and do not necessarily have to be physically illustrated or configured. In other words, the specific form in which respective apparatuses or devices are distributed or integrated is not limited to the one illustrated in the figure, and their entirety or a part is functionally or physically distributed or integrated in any units depending on various loads or usage conditions.

Further, the embodiments and modifications described above can be appropriately combined as long as the processing details between them do not contradict.

Further, the effects described in this specification are merely illustrative or exemplified effects and are not necessarily limitative. That is, with or in the place of the above effects, the technology according to the present disclosure may achieve other effects that are clear to those skilled in the art on the basis of the description of this specification.

Additionally, the technical scope of the present disclosure may also be configured as below.

(1)

A range-finding apparatus including:

an optical receiver configured to receive light to output a pixel signal;

a light source configured to project light with a first irradiation pattern in a first period and project light with a second irradiation pattern in a second period;

a converter configured to sequentially convert the pixel signal bit by bit using binary search to output a first digital signal and a second digital signal, the first digital signal being output by performing the conversion with a first bit width in the first period, the second digital signal being output by performing the conversion with a second bit width in the second period, the second bit width being less than the first bit width; and

a calculation unit configured to calculate a distance on the basis of the first digital signal and the second digital signal.

(2)

The range-finding apparatus according to (1), in which the second bit width has a length of one bit.

(3)

The range-finding apparatus according to (1) or (2), in which the first bit width is a count of bits convertible by the converter to a maximal.

(4)

The range-finding apparatus according to any one of (1) to (3), in which the converter outputs the second digital signal by performing the binary search with a threshold value corresponding to the first digital signal in the second period.

(5)

The range-finding apparatus according to any one of (1) to (4), in which the light source projects the light with a plurality of the second irradiation patterns having different irradiation patterns from each other in the second period, and

the converter outputs a plurality of the second digital signals by performing the binary search, with the threshold value, for the pixel signals respectively corresponding to a plurality of the second irradiation patterns in the second period.

(6)

The range-finding apparatus according to (5), in which the calculation unit integrates a plurality of the second digital signals to calculate the distance.

(7)

The range-finding apparatus according to (6), in which the calculation unit sets a confidence coefficient of the calculated distance to be lower as a value of the first digital signal approximates a value of a saturation region of the optical receiver.

(8)

The range-finding apparatus according to (6) or (7), in which the calculation unit sets, in a case where values of a plurality of the second digital signals are identical, a confidence coefficient of the distance to be lower than in a case where the values are different.

(9)

The range-finding apparatus according to any one of (6) to (8),

in which the light source projects the light with a third irradiation pattern having an irradiation pattern identical to the first irradiation pattern in the second period,

the converter converts a pixel signal corresponding to the third irradiation pattern with the second bit width to output a third digital signal, and

the calculation unit sets a confidence coefficient of the distance on the basis of the third digital signal.

(10)

The range-finding apparatus according to any one of (6) to (9), in which the calculation unit calculates a difference between a plurality of the first digital signals and sets a confidence coefficient of the distance on the basis of the difference.

(11)

The range-finding apparatus according to any one of (1) to (10),

in which the optical receiver

includes a color pixel used for detecting a predetermined color and an infrared (IR) pixel used for detecting infrared light, and

the converter

converts, with the first bit width, a color pixel signal output by the color pixel and a first IR pixel signal output by the IR pixel in the first period and converts, with the second bit width, a second IR pixel signal output by the IR pixel in the second period.

(12)

The range-finding apparatus according to (11), in which the converter performs the conversion on the color pixel signal and the conversion on the first IR pixel signal and the second IR pixel signal at different times.

(13)

The range-finding apparatus according to (11), in which the converter converts the color pixel signal in a fourth period in which the first period and the second period are combined.

(14)

The range-finding apparatus according to any one of (1) to (13),

in which the optical receiver includes a first pixel and a second pixel that each receives the light to output the pixel signal, and

the first period in which the converter converts the pixel signal output by the first pixel with the first bit width is made different from the first period in which the converter converts the pixel signal output by the second pixel with the first bit width.

(15)

The range-finding apparatus according to (14), in which the converter outputs the second digital signal by performing the binary search on the pixel signal output by the second pixel with a threshold value corresponding to the first digital signal obtained by converting the pixel signal output by the first pixel with the first bit width.

(16)

The range-finding apparatus according to any one of (1) to (15), in which the optical receiver receives the light in synchronization with the projection by the light source.

(17)

A range-finding method including:

receiving light to output a pixel signal;

projecting light with a first irradiation pattern in a first period and projecting light with a second irradiation pattern in a second period;

sequentially converting the pixel signal bit by bit using binary search to output a first digital signal and a second digital signal, the first digital signal being output by performing the conversion with a first bit width in the first period, the second digital signal being output by performing the conversion with a second bit width in the second period, the second bit width being less than the first bit width; and

calculating a distance on the basis of the first digital signal and the second digital signal.

### REFERENCE SIGNS LIST

1 Range-finding apparatus
100 Imaging device
200 Projector
300 Entire-apparatus control unit
400 Storage unit
140 Control unit
111 Pixel (image capturing elements)
110 Pixel array section
134A Column ADC
310 Timing control unit
320 Projection image generation unit
330 Data acquisition unit
340 Signal processing unit

1. A range-finding apparatus comprising:
an optical receiver configured to receive light to output a pixel signal;
a light source configured to project light with a first irradiation pattern in a first period and project light with a second irradiation pattern in a second period;
a converter configured to sequentially convert the pixel signal bit by bit using binary search to output a first digital signal and a second digital signal, the first digital signal being output by performing the conversion with a first bit width in the first period, the second digital signal being output by performing the conversion with a second bit width in the second period, the second bit width being less than the first bit width; and
a calculation unit configured to calculate a distance on a basis of the first digital signal and the second digital signal.

2. The range-finding apparatus according to claim 1, wherein the second bit width has a length of one bit.

3. The range-finding apparatus according to claim 1, wherein the first bit width is a count of bits convertible by the converter to a maximal.

4. The range-finding apparatus according to claim 1, wherein the converter outputs the second digital signal by performing the binary search with a threshold value corresponding to the first digital signal in the second period.

5. The range-finding apparatus according to claim 4, wherein the light source projects the light with a plurality of the second irradiation patterns having different irradiation patterns from each other in the second period, and
the converter outputs a plurality of the second digital signals by performing the binary search, with the threshold value, for the pixel signals respectively corresponding to a plurality of the second irradiation patterns in the second period.

6. The range-finding apparatus according to claim 5, wherein the calculation unit integrates a plurality of the second digital signals to calculate the distance.

7. The range-finding apparatus according to claim 6, wherein the calculation unit sets a confidence coefficient of the calculated distance to be lower as a value of the first digital signal approximates a value of a saturation region of the optical receiver.

8. The range-finding apparatus according to claim 6, wherein the calculation unit sets, in a case where values of a plurality of the second digital signals are identical, a confidence coefficient of the distance to be lower than in a case where the values are different.

9. The range-finding apparatus according to claim 6,
wherein the light source projects the light with a third irradiation pattern having an irradiation pattern identical to the first irradiation pattern in the second period,
the converter converts a pixel signal corresponding to the third irradiation pattern with the second bit width to output a third digital signal, and
the calculation unit sets a confidence coefficient of the distance on a basis of the third digital signal.

10. The range-finding apparatus according to claim 6, wherein the calculation unit calculates a difference between a plurality of the first digital signals and sets a confidence coefficient of the distance on a basis of the difference.

11. The range-finding apparatus according to claim 1,
wherein the optical receiver
includes a color pixel used for detecting a predetermined color and an infrared (IR) pixel used for detecting infrared light, and
the converter
converts, with the first bit width, a color pixel signal output by the color pixel and a first IR pixel signal output by the IR pixel in the first period and converts, with the second bit width, a second IR pixel signal output by the IR pixel in the second period.

12. The range-finding apparatus according to claim 11, wherein the converter performs the conversion on the color pixel signal and the conversion on the first IR pixel signal and the second IR pixel signal at different times.

13. The range-finding apparatus according to claim 11, wherein the converter converts the color pixel signal in a fourth period in which the first period and the second period are combined.

14. The range-finding apparatus according to claim 1,
wherein the optical receiver includes a first pixel and a second pixel that each receives the light to output the pixel signal, and
the first period in which the converter converts the pixel signal output by the first pixel with the first bit width is made different from the first period in which the converter converts the pixel signal output by the second pixel with the first bit width.

15. The range-finding apparatus according to claim 14, wherein the converter outputs the second digital signal by performing the binary search on the pixel signal output by the second pixel with a threshold value corresponding to the first digital signal obtained by converting the pixel signal output by the first pixel with the first bit width.

16. The range-finding apparatus according to claim 1, wherein the optical receiver receives the light in synchronization with the projection by the light source.

17. A range-finding method comprising:
receiving light to output a pixel signal;
projecting light with a first irradiation pattern in a first period and projecting light with a second irradiation pattern in a second period;
sequentially converting the pixel signal bit by bit using binary search to output a first digital signal and a second digital signal, the first digital signal being output by performing the conversion with a first bit width in the first period, the second digital signal being output by performing the conversion with a second bit width in the second period, the second bit width being less than the first bit width; and
calculating a distance on a basis of the first digital signal and the second digital signal.
